(19) United States
(12) Patent Application Publication
(10) Pub. No.: US 2025/0134318 A1
(43) Pub. Date: May 1, 2025

(54) ACTIVE STIRRING IN A STAND MIXER APPLIANCE

(71) Applicant: Haier US Appliance Solutions, Inc., Wilmington, DE (US)

(72) Inventors: Rocco Cordaro, Louisville, KY (US); Andrew Combs, Louisville, KY (US); Andre Zdanow, Louisville, KY (US); Kevin Farrelly Nolan, Louisville, KY (US)

(21) Appl. No.: 18/499,503

(22) Filed: Nov. 1, 2023

(51) Int. Cl. A47J 43/08; A47J 43/044

(52) U.S. Cl. CPC A47J 43/082; A47J 43/044; A47J 2043/04454

(57) ABSTRACT

Provided is a method for operating a stand mixer. The stand mixer includes a housing, a motor disposed in the housing, a mixing shaft operably coupled to the motor, and a controller. The method includes receiving, at the controller, a command indicative of starting an active stir mode, rotating, by the motor, the mixing shaft in a variable direction in the active stir mode, thereby stirring food contents, and terminating, by the controller, the active stir mode in response to one of a user input and reaching a predetermined time.

### FIELD OF THE INVENTION

The present subject matter relates generally to operating stand mixers.

### BACKGROUND OF THE INVENTION

Stand mixers are generally used for performing mixing, churning, or kneading involved in food preparation. Typically, stand mixers include a motor configured to provide torque to one or more driveshafts. Users may connect various utensils to the one or more driveshafts, including whisks, spatulas, or the like. Operating a stand mixer is frequently a manual process, which involves the user actively monitoring the mixing process. Thus, during the mixing process, a user is positioned close to the mixer in order to monitor the content doneness and to turn-off the stand mixer when the desired doneness is reached. However, users frequently attend to multiple activities when baking or cooking, and ingredients that have reached the desired doneness can sit in the stand mixer for some time before the user returns to the stand mixer. As such, ingredients can settle out of the mixture and become unincorporated in the stand mixer. For a user, having to re-mix the ingredients can be tedious and inconvenient, and can lead to overworking the ingredients.

Accordingly, a stand mixer configured to prevent the settling of ingredients, as well as avoid overworking ingredients would be advantageous.

### BRIEF DESCRIPTION OF THE INVENTION

Aspects and advantages of the invention will be set forth in part in the following description, or may be apparent from the description, or may be learned through practice of the invention.

In one example embodiment, a method is provided for operating a stand mixer. The stand mixer includes a housing, a motor disposed in the housing, a mixing shaft operably coupled to the motor, and a controller. The method includes receiving, at the controller, a command indicative of starting an active stir mode, rotating, by the motor, the mixing shaft in a variable direction in the active stir mode, thereby stirring food contents, and terminating, by the controller, the active stir mode in response to one of a user input and reaching a predetermined time.

In another example embodiment, a stand mixer includes a housing, a motor disposed in the housing, a mixing shaft operably coupled to the motor, and a controller. The controller is configured to receive a command indicative of starting an active stir mode, rotate, by the motor, the mixing shaft in a variable direction in the active stir mode, thereby stirring food contents, and terminate the active stir mode in response to one of a user input and reaching a predetermined time.

In another example embodiment, a method for operating a stand mixer includes activating an active stir mode, stirring food contents in a variable direction in the active stir mode, and terminating the active stir mode in response to one of a user input and reaching a predetermined time.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of an example stand mixer with a bowl according to example embodiments of the present disclosure.

FIG. 2 provides a perspective view of the stand mixer with a mixing attachment according to example embodiments of the present disclosure.

FIG. 3 illustrates a flow diagram of an example method of operating a stand mixer according to aspects of the present disclosure.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “includes” and “including” are intended to be inclusive in a manner similar to the term “comprising.” Similarly, the term “or” is generally intended to be inclusive (i.e., “A or B” is intended to mean “A or B or both”). Approximating language, as used herein throughout the specification and claims, is applied to modify any quantitative representation that could permissibly vary without resulting in a change in the basic function to which it is related.

The terms “coupled,” “fixed,” “attached to,” and the like refer to both direct coupling, fixing, or attaching, as well as indirect coupling, fixing, or attaching through one or more intermediate components or features, unless otherwise specified herein.

The present invention advantageously provides a mixer appliance with a secure mixing attachment coupling to a mixing shaft of the mixer appliance. This secure coupling may allow the mixer to rotate the shaft with the secured mixing attachment in clockwise and counterclockwise motions. In some embodiments, the ability to rotate mixing attachments in more than one direction may allow for faster, more complete, or more preferred mixing, blending, or other mechanical manipulation of articles mixed or otherwise manipulated by the mixer appliance.

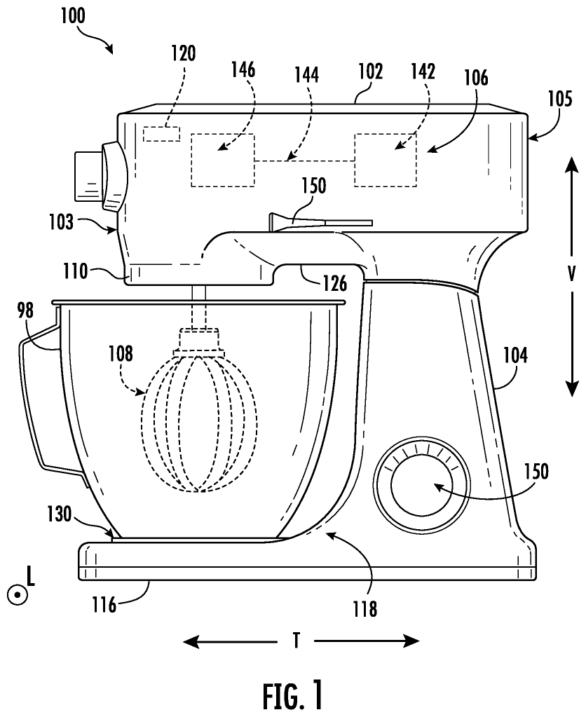

The figures depict an exemplary stand mixer appliance 100 that may be configured in accordance with various aspects of the present disclosure. It should be appreciated that the invention is not limited to any particular style, size, model, or shape for stand mixer appliance 100. The exemplary embodiment in FIG. 1 is for illustrative purposes only. For example, appliance 100 may have different shapes and appearance for one or more parts, different motor and gear configurations, and other differences while remaining within the scope of the claimed subject matter.

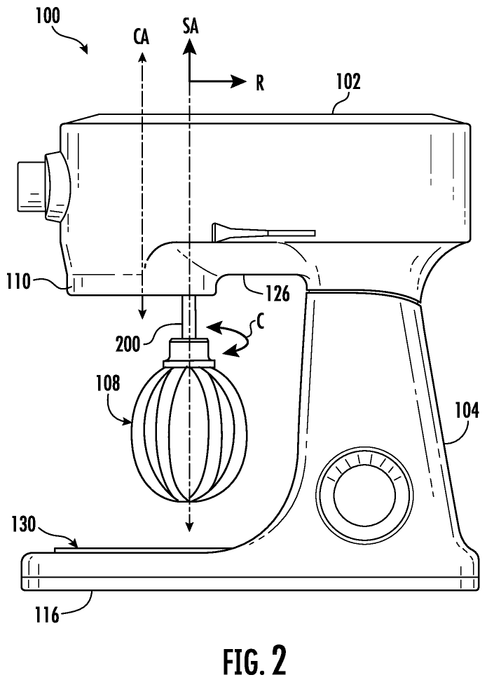

With reference for FIGS. 1 and 2, for the particular embodiment shown, a stand mixer appliance 100 includes a housing, or a head 102, and a base 104 with a casing 106 surrounding head 102. Stand mixer 100 may extend between head 102 and base 104 in a vertical direction V, across head 102 in a lateral direction L, and from a front 103 to a back 105 in a transverse direction T. The vertical direction V, lateral direction L, and transverse direction T are perpendicular to one another.

Head 102 may be pivotally mounted to base 104 and extends transversely between front 103 and back 105 of stand mixer appliance 100 when in the mixing position shown in FIG. 1. In some embodiments, head 102 may be non-pivotably attached to base 104. Other configurations may be used where head 102 may allow for access to a bowl 98 or to a removable mixing attachment 108, as otherwise understood. For this embodiment, base 104 includes upright support 112 and a horizontal base member 116. As shown, upright support 112 extends vertically from horizontal base member 116 and horizontal base member 116 extends transversely in front of upright support 112.

Horizontal base member 116 includes a bowl seat 130 that may be rotatable about a vertical axis. In some embodiments, bowl seat 130 may be concave, grooved, or otherwise shaped to accept bowl 98. In some embodiments, support arms (not shown) or equivalent support structures may be used to hold bowl 98, as would be understood. Other shapes and constructions may be used for bowl seat 130 as well.

Head 102 includes an attachment support 110. A motor 142 is disposed within the housing, i.e., head 102, and enclosed by casing 106. Attachment support 110 is located on a lower portion or underside 126 of head 102 and forward of upright support 112 along transverse direction T. A mixing shaft 200 extends from attachment support 110. Removable mixing attachment 108 removably attaches to shaft 200.

Drivetrain 144 connects motor 142 with one or more gears 146 for causing rotation of attachment 108 or mixing shaft 200, e.g., mixing shaft 200 may be operably coupled to motor 142. Gears 146 may allow for selection by the user of different rotating speeds for attachment 108. In general, mixing attachment 108 may be coupled to shaft 200 prior to rotation of shaft 200 by motor 142.

Stand mixer 100 may include one or more controls 150 for operations such as selectively powering motor 142, choosing the speed of rotation for attachments 108, locking position of head 102 relative to base 104 during mixing, or other features. In some embodiments, controls 150 may include a rotational direction operation selection, allowing a user to select the direction of rotation of the mixing shaft 200.

In certain embodiments, attachment support 110 may accept more than one attachment 108. Various types of attachments 108 may be used including e.g., whisks, paddles, dough hooks, beaters, and others for purposes of mixing articles or mechanically manipulating articles within bowl 98 or other containers supported by base 104. During use, attachment support 110 with mixing shaft 200 may rotate attachment 108 in a circular or planetary fashion. Spinning in a planetary fashion, as used herein, includes spinning an object (e.g., shaft 200) about a first axis and spinning the object about a second axis, the object offset from the second axis. For example, shaft 200 may spin about a shaft axis SA, and spin about a central axis CA, shaft 200 offset from central axis CA to generate spinning in a planetary rotation. Shaft axis SA may also be offset from central axis CA. In some embodiments, motor 142 may be disposed within base 104, including within upright support 112.

As shown in FIG. 2, mixing shaft 200 may rotate within attachment support 110. Mixing attachment 108 and mixing shaft 200 are rotatable by motor 142 in planetary rotation. Mixing shaft may define an axial direction A, with a radial direction R extending therefrom, and a circumferential direction C extending around axial direction (as shown in FIG. 4). Mixing shaft 200 may rotate around axial direction A, mixing shaft 200 further rotating in circumferential direction C in addition to axial direction A. According to the arrangement, axial direction A may correspond to shaft axis SA in some embodiments. Additionally or alternatively, motor 142 may be operable to selectively rotate mixing attachment 108 in a clockwise direction or a counterclockwise direction in circumferential direction C around axial direction A. Mixing shaft 200 may define axial direction A, with radial direction R extending therefrom, and circumferential direction C defined around mixing shaft 200. Thus, mixing shaft 200 may be reversible, or moveable in either direction during use. Attachment of mixing attachment 108 to shaft 200 allows for motion in both directions, clockwise and counterclockwise, by motor 142. In other words, motor 142 can rotate mixing attachment 108 or shaft 200 in a clockwise direction and can switch and rotate mixing attachment 108 or shaft 200 in a counterclockwise direction. Such movement may be directed by a user (e.g., by use of controls 150) or may be directed independent of a user, e.g., by using a timer, by using a controller, described hereinbelow, in operable communication with motor 142, or as otherwise understood.

In general, stand mixer 100 may include a controller 120 provided within casing 106. In detail, controller 120 may be located within head 102 of casing 106. For instance, controller 120 may be a microcontroller, as would be understood, including one or more processing devices, memory devices, or controllers. Controller 120 may include a plurality of electrical components configured to permit operation of stand mixer 100 and various components therein (e.g., motor 142). For instance, controller 120 may be a printable circuit board (PCB), as would be well known.

As used herein, the terms “control board,” “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate appliance operation. Alternatively, controller 120 may be constructed without using a microprocessor, e.g., using a combination of discrete analog and/or digital logic circuitry (such as switches, amplifiers, integrators, comparators, flip-flops, AND/OR gates, and the like) to perform control functionality instead of relying upon software.

Controller 120 may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices can store information and/or data accessible by the one or more processors, including instructions that can be executed by the one or more processors. It should be appreciated that the instructions can be software written in any suitable programming language or can be implemented in hardware. Additionally, or alternatively, the instructions can be executed logically and/or virtually using separate threads on one or more processors.

For example, controller 120 may be operable to execute programming instructions or micro-control code associated with an operating cycle of stand mixer 100. In this regard, the instructions may be software or any set of instructions that when executed by the processing device, cause the processing device to perform operations, such as running one or more software applications, displaying a user interface, receiving user input, processing user input, etc. Moreover, it should be noted that controller 120 as disclosed herein is capable of and may be operable to perform any methods, method steps, or portions of methods as disclosed herein. For example, in some embodiments, methods disclosed herein may be embodied in programming instructions stored in the memory and executed by controller 120. According to still other example embodiments, a controls 150 may include one or more microprocessors and/or one or more memory devices. Accordingly, certain components of stand mixer 100 may be controlled directly from controls 150.

The memory devices may also store data that can be retrieved, manipulated, created, or stored by the one or more processors or portions of controller 120. The data can include, for instance, data to facilitate performance of methods described herein. The data can be stored locally (e.g., on controller 120) in one or more databases and/or may be split up so that the data is stored in multiple locations. In addition, or alternatively, the one or more database(s) can be connected to a remote user interface (not shown) through any suitable network(s), such as through a high bandwidth local area network (LAN) or wide area network (WAN). In this regard, for example, controller 120 may further include a communication module or interface that may be used to communicate with one or more other component(s) of stand mixer 100, controller 120, an external appliance controller, an external device, or any other suitable device, e.g., via any suitable communication lines or network(s) and using any suitable communication protocol. The communication interface can include any suitable components for interfacing with one or more network(s), including for example, transmitters, receivers, ports, controllers, antennas, or other suitable components.

In general, controller 120 may be configured to perform a mixing cycle, whereby stand mixer 100 may be operated to mix food contents, such as food contents in bowl 98. In some example embodiments, the mixing cycle may operates at a first constant speed. For example, the first constant speed may be chosen by the user via controls 150 to achieve desired results of the mixing cycle. Additionally, controller 120 may configured to receive a command indicative of starting an active stir mode. For example, the command indicative of the active stir mode may include one or more of reaching an end of the mixing cycle or receiving a user input indicative of starting the active stir mode, e.g., user manipulation of controls 150.

In general, the active stir mode may include controller 120 configured to rotate, by motor 142, mixing shaft 200 (and thereby attachment 108) in a variable direction in the active stir mode, thereby stirring food contents. For example, the variable direction may include controller 120 configured to rotate mixing shaft 200 in a first direction, such as clockwise rotation, for a first period of time and, upon reaching the first period of time, rotate the mixing shaft in a second direction, such as counterclockwise, opposite the first direction for a second period of time. For example, the first period of time and the second period of time may be any amount of time between five seconds and one hundred and eighty seconds, e.g., the first period of time and the second period of time may be the same time or may be different times. Additionally or alternatively, rotating mixing shaft 200 in the variable direction may include controller 120 configured to rotate mixing shaft 200 at a constant speed, e.g., rotating mixing shaft 200 in the active stir mode includes operating motor 142 at a second constant speed. In particular, the second constant speed of the active stir mode is less than the first constant speed of the mixing cycle. The second constant speed is less than the first constant speed because the active stir mode may aid in preventing the settling of ingredients, while avoiding overworking ingredients, when ingredients have reached the desired doneness and are resting, waiting in stand mixer 100, before the user returns to stand mixer 100 to get the finished product.

Further, controller 120 may be configured to terminate the active stir mode in response to one of a user input and reaching a predetermined time. For example, the variable direction may repeat, e.g., between rotating the mixing shaft in the first direction for the first period of time and rotating the mixing shaft in the second direction for the second period of time, until the active stir mode is terminated. In particular, the predetermined time may be a set period of time of the active stir mode, e.g., a user could specify a length of time for the active stir mode to be active. Moreover, the user input may be user manipulation of controls 150 to terminate the active stir mode, or the user input may be through an external device (not shown), such as a smartphone or any suitable device configured to wirelessly, e.g., through the high bandwidth local area network (LAN) or wide area network (WAN), interface with stand mixer 100.

As one skilled in the art will appreciate, the above described embodiments are used only for the purpose of explanation. Modifications and variations may be applied, other configurations may be used, and the resulting configurations may remain within the scope of the invention. For example, stand mixer 100 is provided by way of example only and aspects of the present subject matter may be incorporated into any other suitable stand mixer appliance.

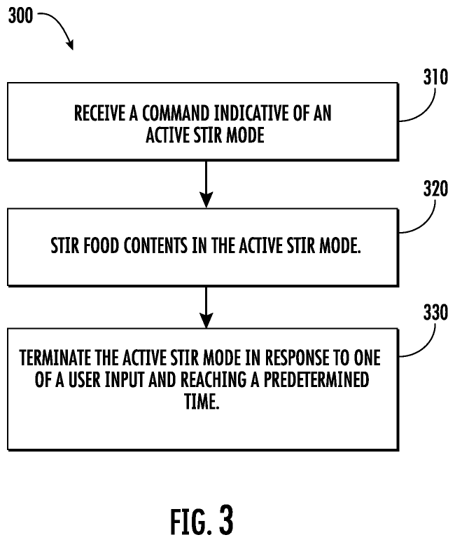

Referring now to FIG. 3, a flow diagram of one embodiment of a method 300 of operating stand mixer 100 is illustrated in accordance with aspects of the present subject matter. In general, method 300 will be described herein with reference to the embodiments of stand mixer 100 and related elements described above with reference to FIGS. 1 and 2. However, it should be appreciated by those of ordinary skill in the art that the disclosed method 300 may generally be utilized in association with apparatuses and systems having any other suitable configuration. In addition, although FIG. 3 depicts steps performed in a particular order for purposes of illustration and discussion, the method discussed herein is not limited to any particular order or arrangement. One skilled in the art, using the disclosures provided herein, will appreciate that various steps of the method disclosed herein can be omitted, rearranged, combined, and/or adapted in various ways without deviating from the scope of the present disclosure.

As shown in FIG. 3, at (310), method 300 may generally include receiving, at controller 120, a command indicative of starting an active stir mode. In particular, receiving the command indicative of an active stir mode may include one or more of reaching an end of the mixing cycle, e.g., the mixing cycle occurring before the active stir mode, or receiving a user input. Thus, the active stir mode may be initiated manually, e.g., in response to the user input, or may be initiated automatically at the end of the mixing cycle.

At (320), method 300 may generally include stirring food contents in the active stir mode. More specifically, (320) may include rotating, by motor 142, mixing shaft 200 in a variable direction in the active stir mode, thereby stirring food contents. As may be seen above, the variable direction may include rotating mixing shaft 200 in a first direction for a first period of time and, upon reaching the first period of time, rotating the mixing shaft in a second direction opposite the first direction for a second period of time. Mixing shaft 200 may rotate at a constant speed, and the variable direction may repeat between rotating the mixing shaft in the first direction and rotating the mixing shaft in the second direction until the active stir mode is terminated.

At (330), method 300 may generally include terminating, by controller 120, the active stir mode in response to one of a user input and reaching a predetermined time. In particular, the predetermined time may be a set period of time of the active stir mode, or the user input may be user manipulation of controls 150 to terminate the active stir mode. Additionally or alternatively, the user input may be through an external device to terminate the active stir mode.

As may be seen from the above, the stand mixer appliance automatically change direction after a predefined amount of time, which may be different for specific recipes, while running at a steady predefined speed. As such, the active stir mode in the stand mixer may advantageously allow users to complete other tasks while preventing the mix in the stand mixer from settling or separating. Additionally, the active stir mode may allow the ingredients to mix more thoroughly with directional changes.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for operating a stand mixer, the stand mixer comprising a housing, a motor disposed in the housing, a mixing shaft operably coupled to the motor, and a controller, the method comprising:
receiving, at the controller, a command indicative of starting an active stir mode;
rotating, by the motor, the mixing shaft in a variable direction in the active stir mode, thereby stirring food contents; and
terminating, by the controller, the active stir mode in response to one of a user input and reaching a predetermined time.

2. The method of claim 1, wherein the variable direction comprises rotating the mixing shaft in a first direction for a first period of time and, upon reaching the first period of time, rotating the mixing shaft in a second direction opposite the first direction for a second period of time.

3. The method of claim 2, wherein rotating the mixing shaft in the variable direction comprises rotating the mixing shaft at a constant speed.

4. The method of claim 3, wherein the variable direction may repeat between rotating the mixing shaft in the first direction and rotating the mixing shaft in the second direction until the active stir mode is terminated.

5. The method of claim 3, further comprising mixing, during a mixing cycle, food contents in the stand mixer.

6. The method of claim 5, wherein the mixing cycle operates at a first constant speed, the active stir mode operating at a second constant speed, the second constant speed of the active stir mode less than the first constant speed of the mixing cycle.

7. The method of claim 5, wherein receiving the command indicative of an active stir mode comprises one or more of reaching an end of the mixing cycle or receiving a user input.

8. A stand mixer, comprising:
a housing;
a motor disposed in the housing;
a mixing shaft operably coupled to the motor; and
a controller, the controller configured to:
receive a command indicative of starting an active stir mode;
rotate, by the motor, the mixing shaft in a variable direction in the active stir mode, thereby stirring food contents; and
terminate the active stir mode in response to one of a user input and reaching a predetermined time.

9. The stand mixer of claim 8, wherein the variable direction comprises the controller configured to rotate the mixing shaft in a first direction for a first period of time and, upon reaching the first period of time, rotate the mixing shaft in a second direction opposite the first direction for a second period of time.

10. The stand mixer of claim 9, wherein rotating the mixing shaft in the variable direction comprises the controller configured to rotate the mixing shaft at a constant speed.

11. The stand mixer of claim 10, wherein the variable direction may repeat between rotating the mixing shaft in the first direction and rotating the mixing shaft in the second direction until the active stir mode is terminated.

12. The stand mixer of claim 10, wherein the controller is further configured to mix, during a mixing cycle, food contents in the stand mixer.

13. The stand mixer of claim 12, wherein the mixing cycle operates at a first constant speed, the active stir mode operating at a second constant speed, the second constant speed of the active stir mode less than the first constant speed of the mixing cycle.

14. The stand mixer of claim 12, wherein the command indicative of an active stir mode comprises one or more of reaching an end of a mixing cycle or receiving a user input.

15. A method for operating a stand mixer, comprising:
activating an active stir mode;
stirring food contents in a variable direction in the active stir mode; and
terminating the active stir mode in response to one of a user input and reaching a predetermined time.

16. The method of claim 15, wherein the variable direction comprises rotating a mixing shaft of the stand mixer in a first direction for a first period of time and, upon reaching the first period of time, rotating the mixing shaft in a second direction opposite the first direction for a second period of time.

17. The method of claim 16, wherein rotating the mixing shaft in the variable direction comprises rotating the mixing shaft at a constant speed.

18. The method of claim 17, wherein the variable direction may repeat between rotating the mixing shaft in the first direction and rotating the mixing shaft in the second direction until the active stir mode is terminated.

19. The method of claim 17, further comprising mixing, during a mixing cycle, food contents in the stand mixer.

20. The method of claim 19, wherein the mixing cycle operates at a first constant speed, the active stir mode operating at a second constant speed, the second constant speed of the active stir mode less than the first constant speed of the mixing cycle.
